(19) United States
(12) Patent Application Publication
(10) Pub. No.: US 2017/0001263 A1
(43) Pub. Date: Jan. 5, 2017

(54) METHOD FOR MANUFACTURING A METAL PART WITH BI-METALLIC CHARACTERISTIC AND MANUFACTURING ARRANGEMENT FOR CONDUCTING SAID METHOD

(71) Applicant: ANSALDO ENERGIA IP UK LIMITED, London (GB)

(72) Inventor: Harald STEINER, Baden (CH)

(73) Assignee: ANSALDO ENERGIA IP UK LIMITED, London (GB)

(21) Appl. No.: 15/199,510

(22) Filed: Jun. 30, 2016

(30) Foreign Application Priority Data
Jul. 1, 2015 (EP) 15174834.0

(51) Int. Cl. B23K 26/342; B23K 26/144; B33Y 80/00; B33Y 10/00; B33Y 30/00; B23K 26/00; B23K 26/70

(52) U.S. Cl. CPC B23K 26/342; B23K 26/0006; B23K 26/144; B23K 26/702; B33Y 10/00; B33Y 30/00; B33Y 80/00; B23K 2203/166

(57) ABSTRACT

A new method for manufacturing a metal part with bi-metallic characteristic in an additive manufacturing process includes providing a first powder of a metal with a first thermal expansion coefficient; providing a second powder of a metal with a second thermal expansion coefficient different from the first thermal expansion coefficient; manufacturing a first pure metal layer by successively melting layers of the first powder alone; manufacturing on the first pure metal layer a mixed layer by successively melting layers of a third powder being a mixture of the first and second powders, whereby the percentage of the first powder decreases from 100% to 0% with increasing thickness of the mixed layer, and whereby the percentage of the second powder increases at the same time from 0% to 100%; and manufacturing a second pure metal layer by successively melting layers of the second powder alone.

### BACKGROUND OF THE INVENTION

The present invention relates to the manufacturing of metal parts. It refers to a method for manufacturing a metal part with bi-metallic characteristic.

It further refers to a manufacturing arrangement for conducting said method.

### PRIOR ART

In thermal turbo machines, especially steam or gas turbines, high thermo-mechanical stresses occur in exposed metal parts or components, which result in low cyclic lifetime of the parts. Furthermore, large deformations occur due to different thermal expansion coefficients or temperature gradients. Also, at small contact areas high contact forces exist and lead to a high wear rate. Finally, large gaps result in chattering, large wear and cracks.

To tackle these problems, welding of parts of dissimilar material may be considered. However, a sharp change-over of different materials leads to additional stresses at elevated temperatures in the heat affected zone (HAZ) of the respective weld seams.

In the prior art, document WO 2014/202352 A1 discloses a method for producing a three-dimensional article or at least a part of such an article made of a gamma prime ([gamma]′) precipitation hardened nickel base super alloy with a high volume fraction (>25%) of gamma-prima phase which is a difficult to weld super alloy, or made of a cobalt base super alloy, or of a non-castable or difficult to machine metal material by means of selective laser melting (SLM), in which the article is produced by melting of layerwise deposited metal powder with a laser beam. The SLM processing parameters are selectively adjusted to locally tailor the microstructure and/or porosity of the produced article or a part of the article and therefore to optimize desired properties of the finalized article/part of the article.

On the other hand, document DE 10 2013 210 876 B4 discloses a composite component for thermal control gap in fluid-flow machines as well as a fluid machine with such a composite component that enables a gap control optimally adapted to the application conditions. The composite component comprises a first and second mcomposite component may be manufactured by means of selective laser melting (SLM).

The known methods are either not suitable for the manufacturing of bi-metallic metal parts (WO 2014/202352 A1) or still comprise disadvantageous sharp transitions between two different metals of the part.

### SUMMARY OF THE INVENTION

It is an object of the present invention to teach a method for manufacturing a metal part with bi-metallic characteristic, which allows improving and tailoring the thermo-mechanic properties of the part.

It is a further object or the present invention to provide a manufacturing arrangement for conducting said method.

These and other objects are obtained by a manufacturing method according to claim 1 and a manufacturing arrangement according to claim 5.

The method according to the invention for manufacturing a metal part with bi-metallic characteristic in an additive manufacturing (AM) process comprises the steps of:
a) providing a first powder of a metal with a first thermal expansion coefficient;
b) providing a second powder of a metal with a second thermal expansion coefficient different from said first thermal expansion coefficient;
c) manufacturing a first pure metal layer by successively melting layers of said first powder alone;
d) manufacturing on said first pure metal layer a mixed layer by successively melting layers of a third powder being a mixture of said first and second powders, whereby the percentage of said first powder decreases from 100% to 0% with increasing thickness of said mixed layer, and whereby the percentage of said second powder increases at the same time from 0% to 100%; and
e) manufacturing a second pure metal layer by successively melting layers of said second powder alone.

According to an embodiment of the invention said mixture of said first and second powders is produced by taking a first quantity of said first powder from a first powder reservoir and a second quantity of said second powder from a second powder reservoir and mixing said first and second quantities in a mixer, whereby said first and second quantities are chosen to generate a new powder layer with a predetermined mixing ratio, and that said mixture of said first and second powders is used in step (d) to manufacture said mixed layer.

Specifically, said mixture of said first and second powders is put as a powder layer of the incomplete metal part by means of a powder layer generating device.

According to another embodiment of the invention said melting is done by using a selective laser melting (SLM) process.

The manufacturing arrangement for conducting said inventive method comprises at least two powder reservoirs, which are connected with their outlets to a mixer for mixing powders from said at least two powder reservoirs to provide at its outlet a mixed powder, further comprising a powder layer generating device, which receives said mixed powder from said mixer and generates a powder layer of said mixed powder on a support, and finally comprising a powder melting means, which interacts with said powder layer to melt said powder layer.

According to an embodiment of the invention said powder melting means comprises an SLM laser source, the laser beam of which is directed on said powder layer.

According to another embodiment of the invention a control is provided for controlling the operation of said mixer and said powder layer generating device and the actual quantities of powder taken from said at least two powder reservoirs.

### BRIEF DESCRIPTION OF THE DRAWINGS

The present invention is now to be explained more closely by means of different embodiments and with reference to the attached drawings.

FIG. 1 shows an example of a bi-metallic metal part manufactured by the method according to the invention, whereby (a) shows a cross-section and (b) shows the respective concentration curves for both metals involved;

FIG. 2 shows an embodiment of a manufacturing arrangement according to the invention;

FIG. 3 shows the thermal expansion for various metals, which may be used in the present invention; and

FIG. 4 shows the welding of dissimilar materials with an intermediate bi-metallic part as shown in FIG. 1.

### DETAILED DESCRIPTION OF DIFFERENT EMBODIMENTS OF THE INVENTION

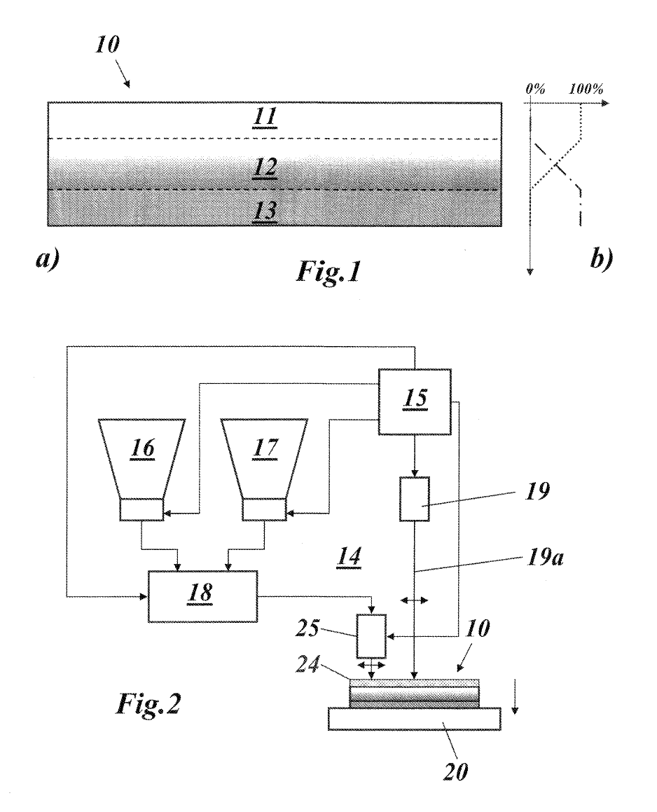

FIG. 1 shows a (simple) example of a bi-metallic metal part 10 manufactured by the method according to the invention, whereby (a) shows a cross-section of metal part 10, and (b) shows the respective concentration curves for both metals involved. Metal part 10 comprises at an upper and at a lower surface two pure layers 11 and 13, whereby pure layer 11 consists 100% of a first metal material, while pure layer 13 consists a 100% of a second metal material. Sandwiched between pure layers 11 and 13 is a mixed layer 12, wherein the concentration of the first metal gradually changes from 100% to 0% (dotted curve in FIG. 1(b)), and the concentration of the second metal gradually changes in opposite direction from 0% to 100% (dot and dash curve in FIG. 1(b)).

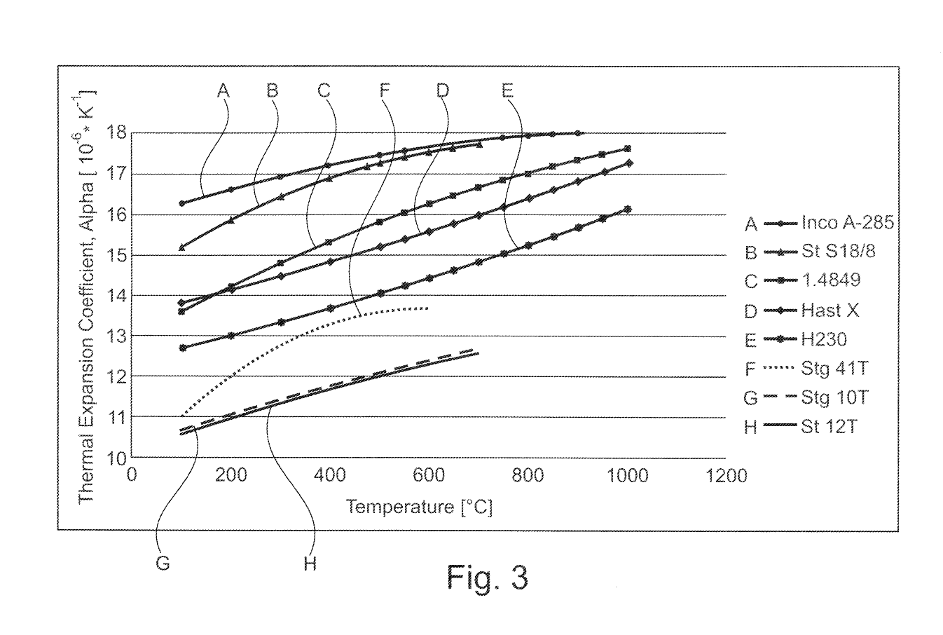

Bi-metallic metal part 10 can be manufactured form respective metal powders by selective laser melting (SLM). FIG. 2 shows as an embodiment of the invention a simplified scheme of a manufacturing arrangement, which may be used to produce a metal part 10 as shown in FIG. 1. Manufacturing arrangement 14 of FIG. 2 comprises two powder reservoirs 16 and 17, which are filled with powders of two metals with different thermal expansion behavior (see for example the thermal expansion curves of various suitable metals in FIG. 3). Each of the reservoirs has an outlet, through which a predetermined quantity of powder can be released to a common mixer 18. The quantities of powder being released are controlled by a control 15, which also controls operation of mixer 18.

The mixed powder or powder mix is then transferred from mixer 18 to a powder layer generating device 25, which generates, controlled by control 15, on a support 20 (or the incomplete metal part 10) a powder layer 24 of suitable thickness. When powder layer 24 is completed, the powder is melted by using an SLM laser source 19 with its laser beam 19a. The control of SLM laser source 19 is also done by control 15.

For manufacturing pure layer 13, pure second metal powder is used. Then, during the SLM process the powder is changed from pure second powder to a successively changing mixture of second and first metal powders (mixed layer 12 in FIG. 1), and finally to pure first metal powder (pure layer 11 in FIG. 1). As explained above, this can be achieved by having the two reservoirs 16 and 17 (with the two different powders) above mixer 18 and the powder layer generating device that puts the powder in layers on the incomplete work piece.

Before a new powder layer 24 is put on the work piece or metal part 10, the powders are filled in the mixer 18 in a variable ratio. As has been said, both powders have a different thermal expansion coefficient. The result is a metal part that consists at one side 100% of one material and on the other side 100% of the other material. In between the material change is gradually (FIG. 1).

In practice, the metal with the larger thermal expansion coefficient (e.g. Hast-X, curve D in FIG. 3, or STS18/8, curve B in FIG. 3) is used for the colder side of the part and the metal with the lower thermal expansion (e.g. Haynes H230, curve E in FIG. 3) is used for the hotter side of the part. The intended deformation in the hot state defines the change point from one powder to the other (position of mixed layer 12). The intended deformation in the hot state could be optimized to be zero with minimal deviation from the design geometry, or a certain intended deformation can be generated to optimize contact pressure and wear.

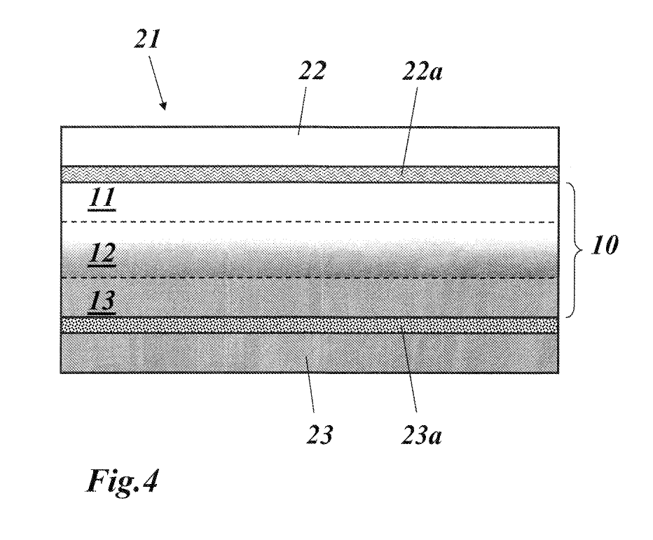

As shown in FIG. 4, a metal part as shown in FIG. 1 could also be used for welding parts of dissimilar material together in a welding component 21. By SLM an intermediate part (10 in FIG. 4) with a smooth and defined changeover from one to another material could be made. Afterwards only weldings with similar materials must be made, i.e. a separate metal part 22 of first metal may be welded to pure layer 11 of first metal of the metal part 10 with a welding seam 22a, and a separate metal part 23 of second metal may be welded to pure layer 13 of second metal of the metal part 10 with a welding seam 23a.

Also, 3 or more different metal materials could be used to establish two or more bi-metal transitions in a stack, for example.

### LIST OF REFERENCE NUMERALS

10 metal part
11,13 pure layer
12 mixed layer
14 manufacturing arrangement
15 control
16,17 powder reservoir
18 mixer
19 SLM laser source
19a laser beam
20 support
21 welded component
22,23 metal part
22a,23a welding seam
24 powder layer
25 powder layer generating device

1. Method for manufacturing a metal part with bi-metallic characteristic in an additive manufacturing process, comprising:
a) providing a first powder of a metal with a first thermal expansion coefficient;
b) providing a second powder of a metal with a second thermal expansion coefficient different from said first thermal expansion coefficient;
c) manufacturing a first pure metal layer by successively melting layers of said first powder alone;
d) manufacturing on said first pure metal layer a mixed layer by successively melting layers of a third powder being a mixture of said first and second powders, whereby the percentage of said first powder decreases from 100% to 0% with increasing thickness of said mixed layer, and whereby the percentage of said second powder increases at the same time from 0% to 100%; and
e) manufacturing a second pure metal layer by successively melting layers of said second powder alone.

2. Method as claimed in claim 1, wherein the mixture of the first and second powders is produced by taking a first quantity of the first powder from a first powder reservoir and a second quantity of the second powder from a second powder reservoir and mixing the first and second quantities in a mixer, whereby the first and second quantities are chosen to generate a new powder layer with a predetermined mixing ratio, and wherein the mixture of the first and second powders is used in step (d) to manufacture said mixed layer.

3. Method as claimed in claim 2, wherein the mixture of the first and second powders is put as a powder layer of the incomplete metal part by a powder layer generating device.

4. Method as claimed in claim 1, wherein the melting is done by using a selective laser melting process.

5. Manufacturing arrangement for manufacturing a metal part with bi-metallic characteristic in an additive manufacturing process, by:
a) providing a first powder of a metal with a first thermal expansion coefficient;
b) providing a second powder of a metal with a second thermal expansion coefficient different from said first thermal expansion coefficient;
c) manufacturing a first pure metal layer by successively melting layers of said first powder alone;
d) manufacturing on said first pure metal layer a mixed layer by successively melting layers of a third powder being a mixture of said first and second powders, whereby the percentage of said first powder decreases from 100% to 0% with increasing thickness of said mixed layer, and whereby the percentage of said second powder increases at the same time from 0% to 100%; and
e) manufacturing a second pure metal layer by successively melting layers of said second powder alone, the arrangement comprising:
at least two powder reservoirs, which are connected with their outlets to a mixer for mixing powders from the at least two powder reservoirs to provide at its outlet a mixed powder, further comprising a powder layer generating device, which receives the mixed powder from the mixer and generates a powder layer of the mixed powder on a support, and comprising a powder melting means, which interacts with the powder layer to melt the powder layer.

6. Manufacturing arrangement as claimed in claim 5, wherein powder melting means comprises:
an SLM laser source, the laser beam of which is directed on the powder layer.

7. Manufacturing arrangement as claimed in claim 5, wherein a control is provided for controlling the operation of the mixer and the powder layer generating device and the actual quantities of powder taken from the at least two powder reservoirs.
